(19) United States
(12) Patent Application Publication
(10) Pub. No.: US 2026/0070198 A1
(43) Pub. Date: Mar. 12, 2026

(54) EXTENSION/CONTRACTION DEVICE AND WIRE TENSIONING DEVICE

(71) Applicant: NAGAKI SEIKI CO., LTD., Osaka (JP)

(72) Inventors: Takashi MIYAKO, Miyagi (JP); Shingo KIMURA, Osaka (JP); Naoki SAIJO, Osaka (JP)

(21) Appl. No.: 19/105,641

(22) PCT Filed: Jun. 20, 2023
(86) PCT No.: PCT/JP2023/022722

§ 371 Date: Feb. 21, 2025

(30) Foreign Application Priority Data
Sep. 1, 2022 (JP) 2022-139413

(51) Int. Cl. B25B 25/00

(52) U.S. Cl. CPC B25B 25/00

(57) ABSTRACT

An extension/contraction device that is used when tensioning a wire is provided. This extension/contraction device comprises an extension/contraction device body and a power unit. The extension/contraction device body has: an outside tubular part; an inside tubular part inserted into the outside tubular part from one axial end thereof; a moving part that has a threaded shaft that passes through the outside tubular part and the inside tubular part, and a nut that is fixed to the other axial end of the inside tubular part and is screwed onto the threaded shaft; and an operating part that rotates the threaded shaft about the center axis to move the nut along the threaded shaft. The power unit is detachably attached to the extension/contraction device body. An engagement part that engages with the operating part, and a motor for rotating the engagement part, are also provided.

### CROSS REFERENCE TO RELATED APPLICATIONS

This application is a 371 U.S. National Phase of International Application No. PCT/JP2023/022722, filed on Jun. 20, 2023, which claims priority to Japanese Patent Application No. 2022-139413, filed Sep. 1, 2022. The entire disclosures of the above applications are incorporated herein by reference.

### BACKGROUND

### Technical Field

The present disclosure relates to an expander and a wire tensioning device.

### Related Art

When performing wire tensioning work in electrical construction, railway maintenance, and or fruit tree trellis creation, it is common to use a wire gripper that grips wire-like bodies such as wires and electric wires, and an expander to perform the work. JP 2018-11495A discloses an expander that performs extending and shortening operation by manually rotating a bolt.

By the way, a great force is required to rotate a bolt. In view of the above circumstances, the present disclosure provides an expander and a wire tensioning device that can easily and accurately perform wire tensioning work.

### SUMMARY

According to an aspect of the present disclosure, an expander adapted to be used to pull wire. The expander includes an expander body and a power part. The expander body includes an outer cylinder portion, an inner cylinder portion inserted into the outer cylinder portion from one end in an axial direction, a moving portion including a screw shaft inserted through the outer cylinder portion and the inner cylinder portion, and a nut fixed to another end of the inner cylinder portion in the axial direction and screwed with the screw shaft, and an operation portion configured to move the nut along the screw shaft by rotating the screw shaft about its axis. The power part is removably mounted to the expander body. The power part includes an engagement portion that engages with the operation portion, and a motor configured to rotate the engagement portion.

According to such an aspect, the expander can be operated easily, so that the wire tensioning work can be performed quickly and safely.

### BRIEF DESCRIPTION OF THE DRAWINGS

FIG. 1 is a front view showing a first embodiment of a wire tensioning device of the present disclosure.

FIG. 2 is a perspective view showing a configuration of a support on the left side in FIG. 1.

FIG. 3 is a perspective view showing a configuration of a support on the right side in FIG. 1.

FIG. 4 is a vertical cross-sectional view showing a configuration near a moving portion and a driving portion in an expander of the first embodiment.

FIG. 5 is a perspective view (internal transparent view) illustrating a schematic configuration of a moving portion in an expander of the first embodiment.

FIG. 6 is a perspective view showing a state in which a power unit is mounted to an expander body in an expander of the first embodiment.

FIG. 7 is a perspective view showing a state in which a power unit is removed from an expander body in an expander of the first embodiment.

FIG. 8 is a cross-sectional view taken along line A-A in FIG. 7.

FIG. 9A to FIG. 9C are partial cross-sectional views for explaining a procedure for mounting a power unit to an expander body in an expander of the first embodiment.

FIG. 10 is a block diagram showing a configuration of a control board in an expander of the first embodiment.

FIG. 11 is a vertical cross-sectional view showing a configuration near a fixing member in an expander of the second embodiment.

FIG. 12 is a perspective view showing a configuration of a fixing member in an expander of the third embodiment.

### DETAILED DESCRIPTION

Hereinafter, an embodiment of the present disclosure will be described with reference to drawings. Various features described in the embodiment below can be combined with each other.

A program for realizing a software in the present embodiment may be provided as a non-transitory computer readable storage medium that can be read by a computer, may be provided for download from an external server, or may be provided in such a manner that the program can be activated on an external computer to realize function thereof on a client terminal (so-called cloud computing).

A term “unit” in the present embodiment may include, for example, a combination of a hardware resource implemented as circuits in a broad sense and information processing of software that can be concretely realized by the hardware resource. Furthermore, various kinds of information are described in the present embodiment, and such information may be represented by, for example, physical values of signal values representing voltage and current, high and low signal values as a set of binary bits consisting of 0 or 1, or quantum superposition (so-called qubits), and communication and computation may be executed on a circuit in a broad sense.

The circuit in a broad sense is a circuit realized by at least properly combining a circuit, circuitry, a processor, a memory, and the like. In other words, a circuit includes an application specific integrated circuit (ASIC), a programmable logic device (e.g., simple programmable logic device (SPLD), a complex programmable logic device (CLPD), field programmable gate array (FPGA), and the like.

### Wire Tensioning Device

First, a wire tensioning device of the present disclosure will be described.

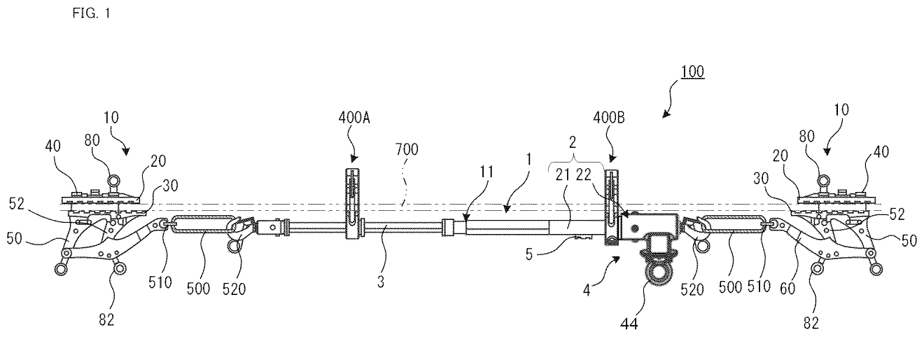

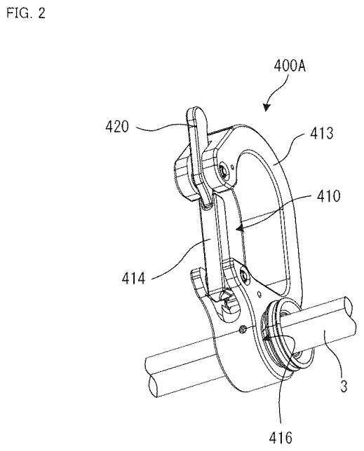

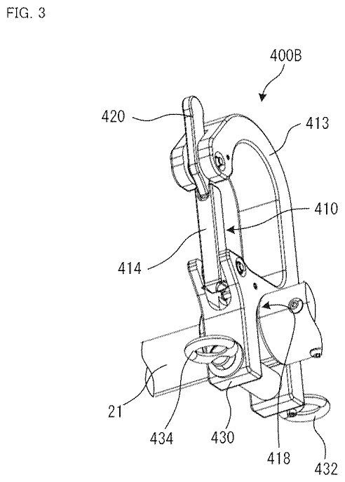

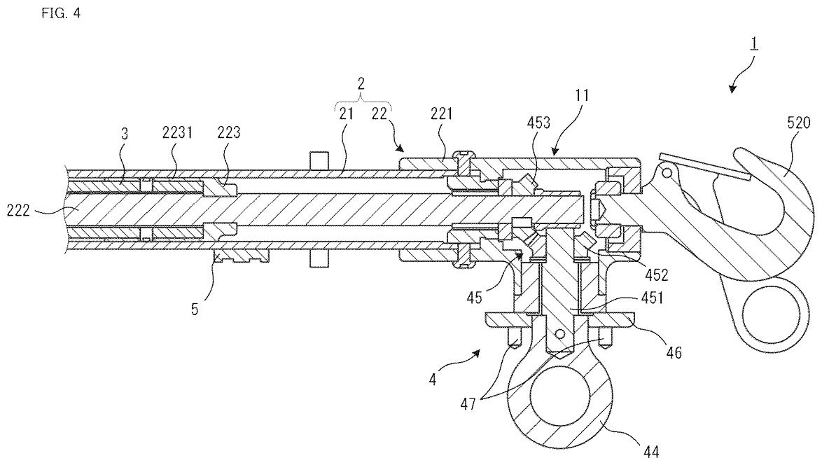

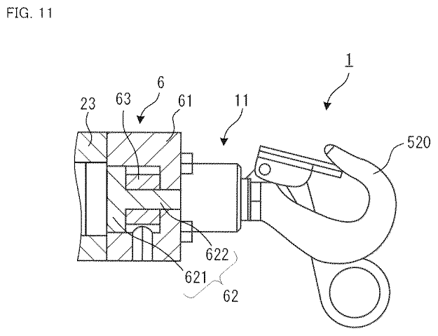

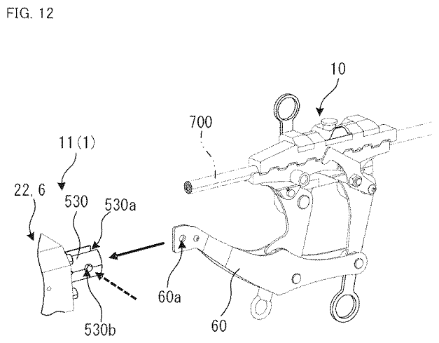

FIG. 1 is a front view showing a first embodiment of a wire tensioning device of the present disclosure. FIG. 2 and FIG. 3 are perspective views each showing a configuration of a support in FIG. 1, respectively. In the following description, an upper side is referred to as “up” or “upward” and a lower side is referred to as “down” or “downward” in FIG. 1 to FIG. 3 (the same applies to FIG. 4 to FIG. 6, FIG. 11 and FIG. 12). In addition, a right side is referred to as “right” or “right side” and a left side is referred to as “left” or “left side” in FIG. 1 to FIG. 3 (the same applies to FIG. 4 to FIG. 6, FIG. 11 and FIG. 12). The wire tensioning device (also referred to as “strain rod”) 100 shown in FIG. 1 is used, for example, to cut a coated electric wire 700 in an aerial state. In FIG. 1, the coated electric wire 700 is indicated by two-dot chain lines.

This wire tensioning device 100 includes a pair of wire grippers 10 for gripping the coated electric wire 700 (overhead wire) and a long expander 1 whose both ends are coupled to these wire grippers 10 via coupling tools 500, 510.

The expander 1 is configured such that the longitudinal dimension thereof can be expanded or contracted by driving a driving portion 4 provided on the right side (another side) of the expander 1 in the longitudinal direction.

### Wire Gripper

A first link piece 50 and a second link piece 52 are pivotally supported on the lower side of a base portion 40 of the wire gripper 10 in a swingable manner. The swing end of the first link piece 50 and the swing end of the second link piece 52 are both coupled to an operation arm 60 to form a parallel link mechanism. As shown in FIG. 1, the coated electric wire 700 is gripped from an up-down direction by an upper wire gripping body 20 and a lower wire gripping body 30. The upper wire gripping body 20 is fixed to the base portion 40. On the other hand, the lower wire gripping body 30 is coupled above the first link piece 50 and the second link piece 52 so that the lower wire gripping body 30 can be brought close to and be separated from the upper wire gripping body 20.

With such a configuration, when the operation arm 60 is pulled toward the expander 1, the first link piece 50 and the second link piece 52 swing. As a result, the lower wire gripping body 30 is displaced upward, i.e., the lower wire gripping body 30 is brought close to the upper wire gripping body 20 and the coated electric wire 700 can be gripped.

The base portion 40 is provided with a support ring 80 that protrudes upward. The support ring 80 is an annular body that constitutes a lifting tool locking body. The support ring 80 can be suspended by a remote control tool to lift the wire gripper 10. The lower wire gripping body 30 is provided with a tightening portion 82 that protrudes downward. The upper wire gripping body 20 and the lower wire gripping body 30 can tighten the coated electric wire 700 by rotating the tightening portion 82.

### Support

The wire tensioning device 100 includes a pair of supports 400A and 400B mounted to the expander 1.

As shown in FIG. 2 and FIG. 3, the supports 400A and 400B each include a substantially C-shaped support body 413 having an opening 410 on one side and a closing piece 414 which closes the opening 410 of the support body 413. With such a configuration, after introducing the coated electric wire 700 into the inside of the support body 413 through the opening 410, the opening 410 of the support body 413 is closed by the closing piece 414, so that the expander 1 can be supported on the coated electric wire 700.

In addition, an engagement piece 420 that engages with the closing piece 414 is rotatably provided in a state in which the opening 410 is closed by the closing piece 414 at the end of the support body 413 facing the opening 410.

As shown in FIG. 2, a through hole 416 through which the expander 1 (moving shaft portion 3) is inserted is formed in the lower part of the support body 413 in the support 400A.

On the other hand, as shown in FIG. 3, a through hole 418 through which the expander 1 (body cylinder portion 2) is inserted is formed in the lower part of the support body 413 in the support 400B.

In addition, the support 400B is provided with a fixing portion 430 in the lower part of the support body 413 for fixing the expander 1 at a desired position in the longitudinal direction and at a predetermined rotation angle around an axis. Furthermore, operation portions 432 and 434 are provided on both sides for operating the fixing portion 430 with a remote control tool.

With this support 400B, an operation for changing the direction of the end of the coated electric wire 700 on the right side after cutting (sorting operation) can be performed so that the ends of the coated electric wire 700 after cutting do not come into contact with each other.

### Expander

The above wire gripper 10 is coupled to both ends of the expander 1. The expander 1 is a device adapted to be used to pull the coated electric wire (wire) 700.

### First Embodiment

First, the first embodiment of the expander will be described.

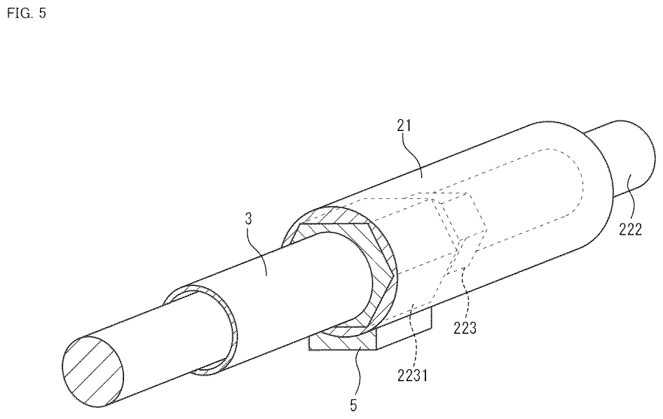

FIG. 4 is a vertical cross-sectional view showing a configuration near a moving portion and a driving portion in an expander of the first embodiment. FIG. 5 is a perspective view (internal transparent view) illustrating a schematic configuration of a moving portion in the expander of the first embodiment.

As shown in FIG. 1 and FIG. 4, the expander 1 includes an expander body 11. The expander body 11 includes a body cylinder portion 2 having a cylindrical shape and a small-diameter cylindrical moving shaft portion (inner cylinder portion) 3 provided so as to be relatively movable in the longitudinal direction of the body cylinder portion 2.

The body cylinder portion 2 includes a cylindrical portion (outer cylinder portion) 21 made of, for example, aluminum or FRP (fiber-reinforced plastic), and a moving portion 22 fixed to the right end (another end) of the cylindrical portion 21 in the axial direction.

The moving shaft portion 3 is inserted into the cylindrical portion 21 from the left end (one end) in the axial direction. The moving shaft portion 3 is formed of, for example, FRP.

The moving portion 22 includes a casing 221 made of, for example, aluminum alloy, a screw shaft 222 inserted through the cylindrical portion 21 and the moving shaft portion 3, and a nut 223 screwed with the screw shaft 222.

The right end of the screw shaft 222 in the axial direction protrudes from the cylindrical portion 21 into the casing 221.

As shown in FIG. 5, the nut 223 has a hexagonal outer shape and is formed with a connecting portion 2231 that protrudes to the left side thereof in the axial direction and has a hexagonal outer shape. The right end (another end) of the moving shaft portion 3 in the axial direction is inserted into and fixed to the inside of the connecting portion 2231. The nut 223 is preferably made of an iron-base metal material.

The inner peripheral surface of the cylindrical portion 21 has a hexagonal shape corresponding to the outer shape of the connecting portion 2231. Thus, the nut 223 is prevented from rotating about the axial direction relative to the cylindrical portion 21.

As shown in FIG. 4, The driving portion 4 includes an operation portion 44 that protrudes from the bottom surface of the casing 221 and is rotated, and a power transmission mechanism 45 coupled to the operation portion 44 and the screw shaft 222 and housed in the casing 221.

The power transmission mechanism 45 includes a shaft portion 451 fixed to the operation portion 44, a bevel gear 452 mounted to the upper end of the shaft portion 451 (the end opposite to the operation portion 44), and a bevel gear 453 mounted on the right end (another end) of the screw shaft 222 and meshed with the bevel gear 452.

The operation portion 44 is configured to rotate the screw shaft 222 about its axis by operating the power transmission mechanism 45. By rotating the screw shaft 222 about its axis, the nut 223 can move back and forth along the screw shaft 222 while being guided by the inner peripheral surface of the cylindrical portion 21. As a result, the moving shaft portion 3 connected to the nut 223 comes in and out with respect to the cylindrical portion 21, thereby allowing the expander body 11 to expand or contract.

A sensor (a position detection portion) 5 configured to detect the position of the nut 223 is provided on the outer circumferential side of the cylindrical portion 21. The expansion/contraction action of the expander body 11 can be performed accurately by detecting the position of the nut 223 with the sensor 5.

The sensor 5 may be a magnetic sensor, an optical sensor, a contact sensor (limit sensor), etc. In the case where the nut 223 is made of a metal material, the sensor 5 is preferably a magnetic sensor. In this case, it is easier to detect the position of the nut 223 more accurately.

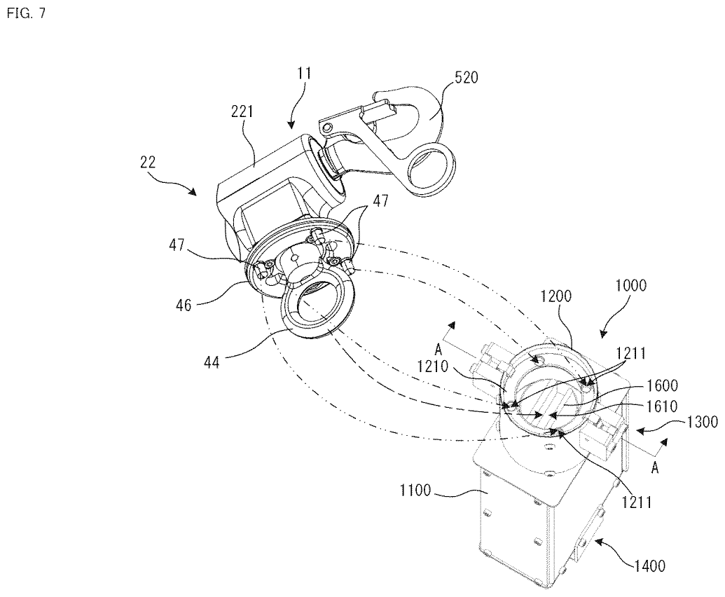

In addition, a fixing member 520 is provided rotatably about the axis of the screw shaft 222 at the right end (another end) of the moving portion 22 (cylindrical portion 21) in the axial direction. As shown in FIG. 1, a coupling tool 500 can be locked with the fixing member 520, and the wire gripper 10 is configured to be coupled to the fixing member 520 via the coupling tool 500. The left end (one end) of the moving shaft portion 3 is also provided with the fixing member 520 capable of locking a coupling tool 500. The fixing member 520 is also configured to be coupled to the wire gripper 10 via the coupling tool 500 in the same manner as described above. As shown in FIG. 4, a disk-shaped flange portion 46 is fixed to the end of the casing 221 on the operation portion 44 side. Furthermore, a plurality of (four in the present embodiment) pins 47 protruding downward (toward the operation portion 44) is provided on the lower surface of the flange portion 46 (see FIG. 7 described later).

A power unit (power part) 1000 is removably mounted to the operation portion 44 of the expander body 11 or in its vicinity as described above. That is, the expander 1 includes the power unit 1000. Here, the operation portion 44 protrudes from the expander body 11 in a direction substantially orthogonal to the axial direction of the screw shaft 222. Thus, the power unit 1000 can be mounted to and removed from the expander body 11 relatively easily.

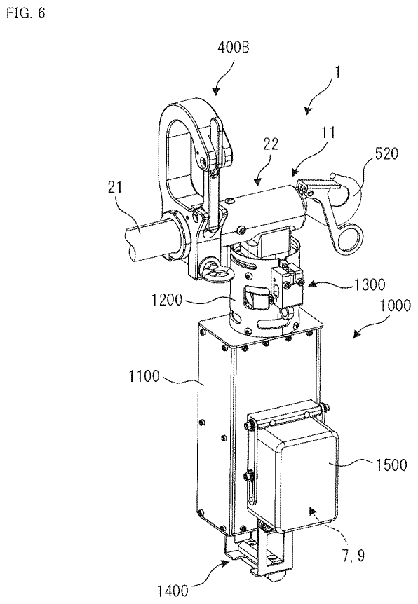

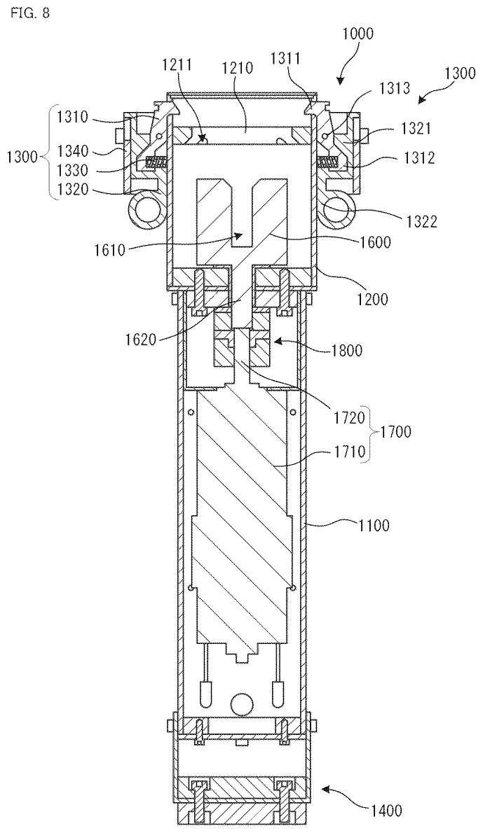

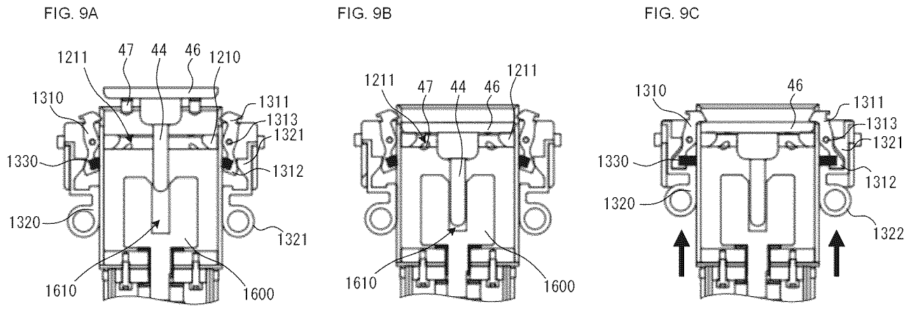

FIG. 6 is a perspective view showing a state in which the power unit is mounted to the expander body in the expander of the first embodiment. FIG. 7 is a perspective view showing a state in which the power unit is removed from the expander body in the expander of the first embodiment. FIG. 8 is a cross-sectional view taken along line A-A in FIG. 7. FIG. 9A to FIG. 9C are partial cross-sectional views for explaining a procedure for mounting the power unit to the expander body in the expander of the first embodiment. In the following description, an upper side is referred to as “up” or “upward” and a lower side is referred to as “down” or “downward”in FIG. 8, and FIG. 9A to FIG. 9C.

The power unit 1000 shown in FIG. 6 includes a case 1100, a mounting portion 1200, a fixing mechanism 1300, a grasping portion 1400, and a cover 1500.

The case 1100 is made of a rectangular parallelepiped member. A motor 1700 is housed in the case 1100, and a motor body 1710 is fixed to the case 1100.

The mounting portion 1200 is connected to the case 1100. The mounting portion 1200 is a portion that is mounted to the expander body 11 and is made of a cylindrical member. The mounting portion 1200 houses the operation portion 44 in a state in which the power unit 1000 is mounted to the expander body 11. The mounting portion 1200 houses an engagement portion 1600 that engages with the operation portion 44.

As shown in FIG. 8, the engagement portion 1600 includes a groove 1610 that opens upward, and a coupling shaft 1620 that protrudes downward.

The engagement portion 1600 engages with the operation portion 44 by inserting the operation portion 44 into the groove 1610. On the other hand, the coupling shaft 1620 is coupled to a rotary shaft 1720 of the motor 1700 via a connecting portion 1800. This allows the motor 1700 to rotate the engagement portion 1600.

With such a configuration, the rotational force of the motor 1700 can be transmitted to the operation portion 44 that engages with the engagement portion 1600, and further can be transmitted to the screw shaft 222 via the power transmission mechanism 45. As a result, the expander body 11 expands or contracts as described above.

A ring portion 1210 that comes into contact with the flange portion 46 is formed on the inner circumferential surface of the mounting portion 1200 along the circumferential direction and protrudes radially inward.

The ring portion 1210 has a plurality of through holes 1211 formed therethrough in the thickness direction. In the present embodiment, the number of through holes 1211 provided is four, corresponding to the number of pins 47 provided. Each pin 47 is inserted into each through hole 1211 in a state in which the power unit 1000 is mounted to the expander body 11. This can prevent rotation of the power unit 1000 relative to the expander body 11. In other words, in the present embodiment, the pins 47 and the through holes 1211 constitute a rotation prevention mechanism of the power unit 1000 relative to the expander body 11.

The number of pins 47 and through holes 1211 provided is not limited to four, but may be one or more, and is preferably two or more. Furthermore, the number of pins 47 provided may be the same as the number of through holes 1211 provided or may be less than the number of through holes 1211 provided. In other words, the number of pins 47 provided and the number of through holes 1211 provided may be the same or different.

The fixing mechanism 1300 is a mechanism for fixing the case 1100 to the expander body 11 in a state in which the power unit 1000 is mounted to the expander body 11. The fixing mechanism 1300 is provided in pairs on the outer circumference of the mounting portion 1200. Each fixing mechanism 1300 includes a lever 1310 that is locked to the flange portion 46, a slider 1320 that displaces the lever 1310, a coil spring 1330 that energizes the lever 1310, and a guide member 1340 that guides the movement of the slider 1320.

The lever 1310 includes a pawl 1311 that is provided at the upper end and comes into contact with the flange portion 46, a spring seat 1312 of the coil spring 1330 provided at the lower end, and an axis 1313 that serves as the center of rotation.

The slider 1320 includes a press portion 1321 that is provided at the upper end and contacts and presses the spring seat 1312 from the outer periphery, and an operation ring 1322 that is provided at the lower end and operates to slide (move) the slider 1320 along the vertical direction.

The spring seat 1312 and the press portion 1321 have opposing surfaces each formed as an inclined surface.

When the press portion 1321 is moved downward, the press portion 1321 presses and displaces the spring seat 1312 along the inclined surface toward the radially inner side of the mounting portion 1200. This causes the pawl 1311 to rotate (displace) radially outward of the mounting portion 1200 (see FIG. 9A and FIG. 9B). At this time, the coil spring 1330 is compressed against the energizing force and enters a compressed state.

From this state, when the press portion 1321 is moved upward, the coil spring 1330 presses and displaces the spring seat 1312 toward the radially outer side of the mounting portion 1200 due to its energizing force. This causes the pawl 1311 to rotate (displace) radially inward of the mounting portion 1200 (see FIG. 8 and FIG. 9C).

The grasping portion 1400 is provided at the lower end of the case 1100. This grasping portion 1400 is a portion that is grasped by a remote control tool (an indirect tool). By grasping the grasping portion 1400 with the remote control tool, the power unit 1000 can be lifted up, and a work of mounting the power unit 1000 to the expander body 11 and a work of removing the power unit 1000 from the expander body 11 can be performed.

The cover 1500 is water-resistant and seals the power supply part 7 and the control board 9 liquid-tightly therein. In addition, in a state in which the power unit 1000 is mounted to the expander body 11, the power supply part 7 and the control board 9 are configured to be connected to electronic components on the expander body 11 side, such as the sensor 5 and load cell 63 described later, by electrical wiring not shown.

The power supply part 7 includes a battery and a battery mounting portion into which the battery is detachably mounted, which are not shown. The power supply part 7 supplies power to at least the motor 1700. In the present embodiment, the power supply part 7 can supply power to the sensor (position detection portion) 5, the motor 1700, and the like.

Note that, the battery may be, for example, a primary battery such as a dry cell or solar cell, or a secondary battery such as a lithium ion battery.

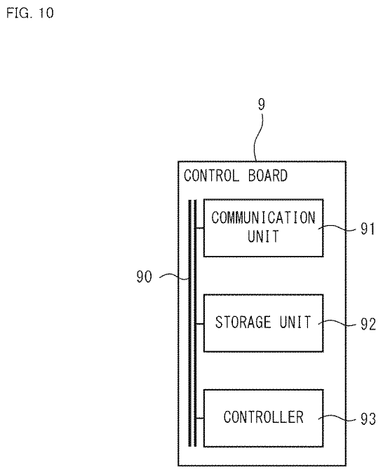

FIG. 10 is a block diagram showing a configuration of the control board in the expander of the first embodiment.

The control board 9 controls at least the motor 1700. The control board 9 shown in FIG. 10 is, for example, a dedicated control device for the sensor (position detection portion) 5, the motor 1700, and the like, which are electrically connected thereto. The control board 9 includes a communication unit 91, a storage unit 92, and a controller 93, which are electrically connected via a communication bus 90.

The communication unit 91 is configured to transmit various electrical signals from the control board 9 to an external component. Furthermore, the communication unit 91 is configured to receive various electrical signals from an external component to the control board 9. More preferably, the communication unit 91 has a network communication function, thereby various information can be communicated with an external apparatus via a network such as the Internet. The communication unit 91 may be preferably wired communication means such as USB, IEEE1394, Thunderbolt (registered trademark), wired LAN network communication, and the like, but may include wireless LAN network communication, mobile communication such as 3G/LTE/5G, Bluetooth (registered trademark) communication, and the like as needed. In other words, more preferably, the communication unit 91 is implemented as a set of these communication means.

The storage unit 92 is configured to store various information as defined by the above description.

This may be implemented as a storage device such as a solid state drive (SSD) storing various programs related to the expander 1 that are executed by the controller 93, or as a memory such as a random access memory (RAM) that stores temporarily necessary information (argument, sequence, etc.) for program operation.

The storage unit 92 stores various programs, variables, etc. related to the expander 1 that are executed by the controller 93. Particularly preferably, information on the construction plan to be performed using the expander 1 is stored.

The controller 93 processes and controls overall operation pertaining to the expander 1.

The controller 93 is, for example, an unshown central processing unit (CPU). The controller 93 realizes various functions pertaining to the expander 1 by reading a predetermined program stored in the storage unit 92. In other words, the controller 93 as an example of hardware is configured to concretely realize information processing of software stored in the storage unit 92.

The controller 93 is not limited to being a single controller but may be implemented with a plurality of controllers 93 for each function. Moreover, a combination thereof may be applied.

Next, the use of the wire tensioning device 100 will be described.
[1] First, the supports 400A and 400B are attached to the coated electric wire 700 using a remote control device.
[2] Next, a pair of wire grippers 10 coupled to both ends of the expander 1 is mounted to the coated electric wire 700 using a remote control tool. Specifically, the remote control device is hooked onto the support ring 80 to suspend the wire gripper 10. Then, the coated electric wire 700 is inserted between the upper wire gripping body 20 and the lower wire gripping body 30, and the upper wire gripping body 20 is hooked onto the coated electric wire 700.
[3] Next, the coated electric wire 700 is tightened by the upper wire gripping body 20 and the lower wire gripping body 30 by rotating the tightening portion 82.
[4] Next, the grasping portion 1400 is grasped with a remote control tool to lift up the power unit 1000. At this time, the slider 1320 is positioned downward and the pawl 1311 of the lever 1310 is displaced radially outward of the mounting portion 1200. In this state, the mounting portion 1200 is brought close to the operation portion 44 of the expander body 11 (see FIG. 9A).

When the mounting portion 1200 is brought even closer to the operation portion 44 of the expander body 11, the outer periphery of the operation portion 44 is covered by the mounting portion 1200 and the operation portion 44 is inserted into the groove 1610 of the engagement portion 1600 (see FIG. 9B). In this state, the engagement portion 1600 engages with the operation portion 44. At this time, each of the pins 47 is inserted into the corresponding through hole 1211, thereby preventing the power unit 1000 from rotating relative to the expander body 11.

Then, when the slider 1320 is slid upward, the pawl 1311 of the lever 1310 is displaced radially inward of the mounting portion 1200 as described above. In this state, the pawl 1311 of the lever 1310 is locked to the upper edge of the flange portion 46 (see FIG. 9C). As a result, the power unit 1000 is fixed to the expander body. That is, the power unit 1000 is prevented from being removed from the expander body.
[5] Then, an external terminal (not shown) is used to actuate the motor 1700 to rotate the rotary shaft 1720 in a predetermined direction. Consequently, the operation portion 44, that engages with the engagement portion 1600 also rotates in the same direction. As a result, the screw shaft 222 coupled to power transmission mechanism 45 rotates about its axis, and the nut 223 screwed with the screw shaft 222 moves in the light direction along the longitudinal direction of the screw shaft 222.

At this time, the moving shaft portion 3 fixed to the nut 223 also moves in the right direction and is pulled into the cylindrical portion 21. That is, the expander body 11 contracts. This allows the pair of wire grippers 10 gripping the coated electric wire 700 to be brought close to each other.

As a result, the coated electric wire 700 is in a taut state on the outer side of the wire gripper 10, and in the portion of the coated electric wire 700 between the two wire grippers 10, the coated electric wire 700 is loosened. Then, the loosened portion of the coated electric wire 700 is cut by a cutting tool for indirect live wire.

At this time, the actuation of the motor 1700 is stopped by operating an external terminal. This allows the expander body 11 to be maintained in a contracted state.

The power unit 1000 may be mounted to the expander body 11 prior to the above steps [1] to [3].
[6] After completing the work, the external terminal is operated to actuate the motor 1700 and rotate the rotary shaft 1720 in the opposite direction to the above. As a result, the longitudinal dimension of the expander body 11 is extended, and the wire grippers 10 are separated from each other.

Thereafter, the tightening portion 82 is rotated using the remote control tool to loosen the tightening of the coated electric wire 700 by the upper wire gripping body 20 and the lower wire gripping body 30, thereby releasing the gripping of the coated electric wire 700.

Next, the pair of wire grippers 10 connected to both ends of the expander 1 is removed from the coated electric wire 700 using a remote control tool. Furthermore, the supports 400A, 400B are removed from the coated electric wire 700 by using a remote control tool.

In this manner, the wire tensioning device 100 can be retrieved.

### Second Embodiment

Next, the second embodiment of the expander 1 will be described.

Hereinafter, although the expander 1 of the second embodiment will be described, a description will be mainly given of differences from the expander 1 of the first embodiment, and the description of similar matters will be omitted.

FIG. 11 is a vertical cross-sectional view showing a configuration near a fixing member in the expander of the second embodiment.

In the expander 1 shown in FIG. 11, a tension detection portion 6 configured so as to detect the tension applied to the coated electric wire (wire) 700 is provided at the right end (another end) of the moving portion 22 (the cylindrical portion 21) in the axial direction.

In the present embodiment, the tension detection portion 6 is fixed to the casing 221 of the moving portion 22 (the right end of the body cylinder portion 2) via a spacer 23.

The tension detection portion 6 includes a casing 61, a stress applying member 62 having a T-shaped cross section, and a load cell (pressure sensor) 63 located between the casing 61 and the stress applying member 62.

The stress applying member 62 includes a disk-shaped portion 621 and a rod-like portion 622 protruding from the disk-shaped portion 621 to the right side in the axial direction. The rod-like portion 622 is provided so as to penetrate the casing 61, and a fixing member 520 is fixed (connected) to the right end thereof in the axial direction.

A load cell 63 is arranged between the disk-shaped portion 621 and the casing 61 in contact therewith. When the fixing member 520 is pulled, the stress applying member 62 fixed thereto is also pulled, and the load cell 63 is compressed by the disk-shaped portion 621 (i.e., stress is applied to the load cell 63). This makes it possible to detect the tension applied to the coated electric wire 700.

The expander 1 of the second embodiment can also provide the same functions and effects as those of the expander 1 of the first embodiment.

In particular, by providing the tension detection portion 6, it is possible to prevent the application of more tension than necessary to the coated electric wire 700. This allows the wire tensioning operation to be carried out safely. In particular, the above-mentioned effects can be further improved by the combination with the sensor 5.

From a similar viewpoint, a sensor capable of measuring a current value flowing through the motor 1700 may be provided. In this case, the torque when the motor 1700 is driven can be grasped by measuring the current value. Specifically, as the current value increases, the torque generated when the motor 1700 is driven increases. Thus, by measuring the current value flowing through the motor 1700, it is possible to prevent the application of more tension than necessary to the coated electric wire 700.

In addition, when the expander body 11 is extended and the nut 223 comes into contact with the left end (one end) of the cylindrical portion 21, or when the expander body 11 contracts and the nut 223 comes into contact with the moving portion 22 (casing 221), the rotation of the motor 1700 stops and the current value flowing to the motor 1700 increases. Thus, by measuring the current value flowing to the motor 1700, the position of the nut 223 can also be detected.

### Third Embodiment

Next, the third embodiment of the expander 1 will be described.

Hereinafter, although the expander 1 of the third embodiment will be described, a description will be mainly given of differences from the expander 1 of the first and the second embodiments, and the description of similar matters will be omitted.

FIG. 12 is a perspective view showing a configuration of a fixing member in the expander of the third embodiment.

The fixing member 530 shown in FIG. 12 has a cylindrical shape and is provided at the right end (another end) of the moving portion 22 in the axial direction or is joined to or integrally formed with the stress applying member 62. The fixing member 530 includes a groove 530a formed along the axial direction and a through hole 530b formed penetrating along a direction substantially orthogonal to the axial direction. The operation arm 60 of the wire gripper 10 also includes a through hole 60a formed at its left end (one end) along a direction substantially orthogonal to the axial direction.

The left end of the operation arm 60 is inserted into the groove 530a of the fixing member 530, and the through hole 530b is aligned with the through hole 60a. Thereafter, a bolt (not shown) is inserted through the through hole 530b and the through hole 60a, and a nut (not shown) is screwed with the protruding end. This allows the wire gripper 10 to be coupled to the end of the expander body 11.

The expander 1 of the third embodiment can also provide the same functions and effects as those of the expander 1 of the first and second embodiments. The type of the wire gripper 10 is also selected depending on the type of wire to be gripped. Then, the expander 1 including the fixing member 530 or the fixing member 520 having a shape (configuration) suitable for coupling is selected depending on the configuration (shape) of the operation arm 60 of the wire gripper 10 to be selected.

In the case where the tension detection portion 6 is omitted, the fixing member 530 (the same applies to the fixing member 520) is provided at the right end (another end) of the moving portion 22 in the axial direction.

As described above, according to the first to third embodiments, the expanding and contracting actions of the expander body 11 are configured to be performed by the power unit 1000 having the motor 1700. Thus, the expander 1 itself assists in the work that requires a large amount of force, thus improving operability.

In particular, the power unit 1000 is removably mounted to the expander body 11. Thus, the power unit 1000 can be easily replaced with one including a motor 1700 that has a different torque depending on the force required to rotate the screw shaft 222.

In addition, a power supply and a control board for the sensor 5 may be separately incorporated into the expander body 11.

Furthermore, the expander body 11 may be used as it is as the expander 1 without mounting the power unit 1000. In this case, a remote control tool is engaged with the operation portion 44, and this remote control tool is used to rotate the operation portion 44.

In addition, by using the power unit 1000, whereas conventionally two workers on a bucket in the air are required to work, it becomes possible for a single worker to work on the bucket in the air, thus improving workability. In addition, the remaining worker can grasp the work status of the worker on the bucket from the ground and give accurate instructions, thus improving safety.

In particular, the sensor 5 is provided, thus enabling the expansion and contraction of the expander body 11 to be accurately performed. In addition, the tension detection portion 6 is provided, so that the coated electric wire 700 can be prevented from being pulled more than necessary, and breakage or the like of the coated electric wire 700 can be prevented.

In this case, data obtained during work from these detection portions can be transmitted to an external terminal (such as a tablet terminal, etc.) via the communication unit 91 of the control board 9 and can be stored there. Then, it is possible to check the work history and manage the need for repairs, etc. to the expander 1 based on the obtained data, which is also preferable from the viewpoint of improving safety.

The external terminal may be a foot switch, a voice recognition device, etc. In this case, even in the case of working alone, both hands can be freed when operating the expander body 11.

In addition, even in the case where a plurality of coated electric wires (wire-like bodies) 700 are simultaneously worked on using the respective wire tensioning devices 100, the wire tensioning work and the like can be performed using a single external terminal.

In addition, in the present disclosure, any two or more of the configurations of the first to third embodiments may be combined.

A plurality of sensors 5 may be provided along the axial direction of the cylindrical portion 21.

In this case, by detecting the position of the nut 223 with one sensor 5, the moving shaft portion 3 can be configured so as to be prevented from protruding more than necessary from the cylindrical portion 21 (body cylinder portion 2) and falling off.

In addition, by detecting the position of the nut 223 with another sensor 5, it is possible to configure to define (set) the initial position of the moving shaft portion 3 relative to the cylindrical portion 21 (body cylinder portion 2).

Furthermore, by detecting the position of the nut 223 with another sensor 5, it is possible to configure to prevent the moving shaft portion 3 from retracting more than necessary relative to the cylindrical portion 21 (body cylinder portion 2).

In addition, the present disclosure may be provided in each of the following aspects.

(1) An expander adapted to be used to pull wire, comprising: an expander body and a power part removably mounted to the expander body, the expander body including an outer cylinder portion, an inner cylinder portion inserted into the outer cylinder portion from one end in an axial direction, a moving portion including a screw shaft inserted through the outer cylinder portion and the inner cylinder portion, and a nut fixed to another end of the inner cylinder portion in the axial direction and screwed with the screw shaft, and an operation portion configured to move the nut along the screw shaft by rotating the screw shaft about its axis, the power part including an engagement portion that engages with the operation portion, and a motor configured to rotate the engagement portion.

(2) The expander according to (1), wherein: the operation portion protrudes from the expander body in a direction substantially orthogonal to the axial direction of the screw shaft.

(3) The expander according to (1) or (2), wherein: the power part further includes a case that houses the motor, a mounting portion that is connected to the case and houses the engagement portion, and a fixing mechanism that fixes the case to the expander body.

(4) The expander according to any one of (1) to (3), further comprising: a rotation prevention mechanism of the power part relative to the expander body.

(5) The expander according to any one of (1) to (4), further comprising: a power transmission mechanism coupled to the screw shaft, wherein the operation portion is configured to rotate the screw shaft about its axis by operating the power transmission mechanism.

(6) The expander according to any one of (1) to (5), further comprising: a power supply part configured to supply power to at least the motor.

(7) The expander according to any one of (1) to (6), further comprising: a controller configured to control at least the motor.

(8) A wire tensioning device, comprising: an expander configured by the expander according to any one of (1) to (7); and a pair of wire grippers each coupled to both ends of the expander.

Of course, the present disclosure is not limited to the above aspects.

Finally, various embodiments of the present disclosure have been described, but these are presented as examples and are not intended to limit the scope of the invention. Novel embodiments can be implemented in various other forms, and various omissions, replacements, and modifications can be made within the scope of the spirit of the invention. The embodiments and its modifications are included in the scope and the spirit of the invention and are included in the scope of the invention described in claims and the equivalent scope thereof.

1. An expander adapted to be used to pull wire, comprising:
an expander body and a power part removably mounted to the expander body,
the expander body including
an outer cylinder portion,
an inner cylinder portion inserted into the outer cylinder portion from one end in an axial direction,
a moving portion including a screw shaft inserted through the outer cylinder portion and the inner cylinder portion, and a nut fixed to another end of the inner cylinder portion in the axial direction and screwed with the screw shaft, and
an operation portion configured to move the nut along the screw shaft by rotating the screw shaft about its axis,
the power part including
an engagement portion that engages with the operation portion, and
a motor configured to rotate the engagement portion.

2. The expander according to claim 1, wherein:
the operation portion protrudes from the expander body in a direction substantially orthogonal to the axial direction of the screw shaft.

3. The expander according to claim 1, wherein:
the power part further includes a case that houses the motor, a mounting portion that is connected to the case and houses the engagement portion, and a fixing mechanism that fixes the case to the expander body.

4. The expander according to claim 1, further comprising:
a rotation prevention mechanism of the power part relative to the expander body.

5. The expander according to claim 1, further comprising:
a power transmission mechanism coupled to the screw shaft, wherein
the operation portion is configured to rotate the screw shaft about its axis by operating the power transmission mechanism.

6. The expander according to claim 1, further comprising:
a power supply part configured to supply power to at least the motor.

7. The expander according to claim 1, further comprising:
a controller configured to control at least the motor.

8. A wire tensioning device, comprising:
an expander configured by the expander according to claim 1; and
a pair of wire grippers each coupled to both ends of the expander.
